(19) United States
(12) Patent Application Publication
(10) Pub. No.: US 2008/0280709 A1
(43) Pub. Date: Nov. 13, 2008

(54) Power Transmission Device

(75) Inventor: Michael Gouadec, Saitama (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: SANDEN CORPORATION, Isesaki-shi, Gunma (JP)

(21) Appl. No.: 11/569,847

(22) PCT Filed: Jul. 28, 2005
(86) PCT No.: PCT/JP2005/013815

§ 371 Date: Nov. 30, 2006

(30) Foreign Application Priority Data
Aug. 30, 2004 (JP) 2004-250267

(51) Int. Cl. F16D 3/68; F16D 3/50; F16D 7/10; F16F 15/12; F16H 35/10; F16H 55/36

(52) U.S. Cl. 474/94

(57) ABSTRACT

An object of the present invention is to provide a power transmission device in which the cushioning effect due to a cushioning member can be maintained for a long period of time, and the process for assembling the cushioning member can be simplified. In the power transmission device in accordance with the present invention, A plurality of convex portions (30a) are provided on the outer peripheral surface of a cushioning rubber (30) at intervals in the circumferential direction. A plurality of concave portions (10b) are provided in the inner peripheral surface of a pulley (10) at intervals in the circumferential direction. The convex portions (30a) are fitted in the concave portions (10b). Therefore, the cushioning rubber (30) transmits turning force while being deformed elastically in the shear direction between the pulley (10) and an inner ring (20). Thereupon, the cushioning rubber (30) is not deformed elastically in the repeated compression direction, so that permanent deformation does not occur in the compression direction.

### TECHNICAL FIELD

The present invention relates to a power transmission device for transmitting power from a driving source of a vehicle to a compressor for a vehicular air conditioner, for example.

### BACKGROUND ART

A generally known compressor for a vehicular air conditioner includes a compressor body being hollowed inside, a compression mechanism for compressing a fluid sucked in the compressor body, and a driveshaft connected to the compression mechanism. Also, in this compressor, when the drive shaft is rotated by the power of an engine, the compression mechanism is driven. This compressor sucks and discharges a refrigerant by means of driving of the compression mechanism.

Also, a power transmission device provided for the above-described compressor includes a first rotor capable of being rotated by the power of the engine, a second rotor disposed on the inside in the radial direction of the first rotor, and a third rotor which is connected to the second rotor via a cutoff mechanism and is capable of being rotated together with the drive shaft. The first rotor has a plurality of protruding portions provided at intervals in the circumferential direction. The second rotor has a plurality of protruding portions facing the protruding portions of the first rotor in the circumferential direction. A plurality of cushioning members are provided between the protruding portions of the first rotor and the protruding portions of the second rotor, and each of the cushioning members has a block shape. Each of the cushioning members transmits turning force from the first rotor to the second rotor.

Patent Document 1: Japanese Patent Publication 2003-269489

### DISCLOSURE OF THE INVENTION

### Problem to be Solved by the Invention

In the above-described power transmission device, when the first rotor is rotated by the power from the engine, the cushioning members deform elastically in the circumferential direction of the first rotor. That is to say, the cushioning members deform elastically in the compression direction. Thereby, the rotational fluctuations transmitted from the engine are absorbed by the cushioning members. Also, the cushioning members transmit turning force from the first rotor to the second rotor. Therefore, the elastic deformation of the cushioning members is repeated in the compression direction, so that permanent deformation in the compression direction occurs in the cushioning members. Also, the permanent deformation decreases the cushioning effect. Further, a gap is produced between the protruding portion of each of rotors and the cushioning member by the permanent deformation. The gap produces vibrations between the first rotor and the second rotor.

Also, since a plurality of cushioning members are provided between the first rotor and the second rotor, the number of parts and the number of assembling processes are large, which leads to a high manufacturing cost.

An object of the present invention is to provide a power transmission device in which the cushioning effect due to a cushioning member can be maintained for a long period of time, and the process for assembling the cushioning member can be simplified.

### Means for Solving the Problem

To achieve the above object, a power transmission device in accordance with the present invention includes a first rotor capable of being rotated by power from the outside, a second rotor disposed on the inside in the radial direction of the first rotor, a ring-shaped cushioning member for transmitting turning force from the first rotor to the second rotor, the cushioning member which is disposed between the first rotor and the second rotor, and the cushioning member in which the inner peripheral surface is fixed to the outer peripheral surface of the second rotor, a third rotor disposed on the inside in the radial direction of the second rotor, a cutoff mechanism which is disposed between the second rotor and the third rotor, the cutoff mechanism which is capable of transmitting turning force from the second rotor to the third rotor, and the cutoff mechanism which cuts off the turning force transmitted from the second rotor to the third rotor in the case in which a torque larger than a predetermined amount is produced between the second rotor and the third rotor, a plurality of convex portions provided at intervals in the circumferential direction with each other on the outer peripheral surface of the cushioning member, and a plurality of concave portions which are provided in the inner peripheral surface of the first rotor, and the concave portions which are fitted on the convex portions of the cushioning member.

Thereby, since the convex portions of the cushioning member are fitted in the concave portions of the first rotor, turning force is transmitted from the first rotor to the outer peripheral surface of the cushioning member. Also, since the inner peripheral surface of the cushioning member is fixed to the second rotor, turning force is transmitted from the inner peripheral surface of the cushioning member to the second rotor. Therefore, the cushioning member transmits turning force while being deformed elastically in the shear direction between the outer peripheral surface and the inner peripheral surface. Also, the cushioning member is fixed on the outer peripheral surface of the second rotor, and the cushioning member and the first rotor are connected to each other by fitting. Therefore, the work for assembling the cushioning member is easy to perform.

### EFFECT OF THE INVENTION

According to the power transmission device in accordance with the present invention, the cushioning member transmits turning force while being deformed elastically in the shear direction between the outer peripheral surface and the inner peripheral surface. Therefore, unlike the conventional example, the cushioning member is not deformed elastically in the compression direction repeatedly. That is to say, permanent deformation in the compression direction does not occur in the cushioning member, so that the cushioning effect does not decrease. Therefore, the cushioning effect due to the cushioning member can be maintained for a long period of time. Also, since the work for assembling the cushioning member is easy to perform, the manufacturing cost can be reduced.

The above and other objects, features, and advantages of the present invention will become more apparent from the following description and the accompanying drawings.

### BRIEF DESCRIPTION OF THE DRAWINGS

FIG. 1 is a side sectional view of a power transmission device in accordance with a first embodiment of the present invention;

FIG. 2 is a sectional view of A-A line in FIG. 1;

FIG. 3 is a side sectional view of a power transmission device, showing the operation thereof at the power cutoff time;

FIG. 4 is a perspective view showing a state before a cushioning rubber and a pulley are assembled;

FIG. 5 is a perspective view of a torque transmission ring;

FIG. 6 is a perspective view of an inner ring;

FIG. 7 is a perspective view of an inner ring on which a cushioning rubber is molded;

FIG. 8 is a sectional view of B-B line in FIG. 7;

FIG. 9 is a perspective view of an inner ring to which a cutoff mechanism is assembled; and

FIG. 10 is a side sectional view of a power transmission device in accordance with a second embodiment of the present invention.

### DESCRIPTION OF SYMBOLS

1 . . . compressor body, 2 . . . drive shaft, 10 . . . pulley, 10b . . . concave portion, 20 . . . inner ring, 20a . . . contact portion, 20b . . . first inclined face, 21 . . . torque transmission ring, 21a . . . inner peripheral surface, 21b . . . outer peripheral surface, 30 . . . cushioning rubber, 30a . . . convex portion, 40 . . . hub, 40c . . . ball groove, 40d . . . contact plate, 40e . . . second inclined face, 41 . . . ball, 42 . . . pressing ring, 43 . . . belleville spring, 44 . . . nut, 50 . . . hub, 51 . . . pin, 52 . . . torque plate, TL . . . cutoff mechanism

### BEST MODE FOR CARRYING OUT THE INVENTION

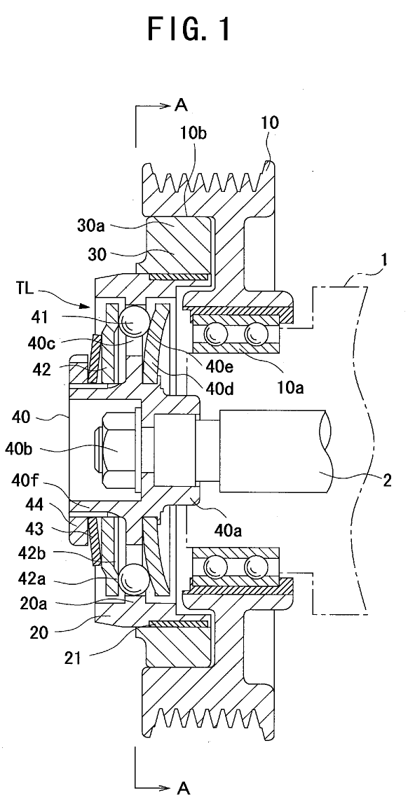

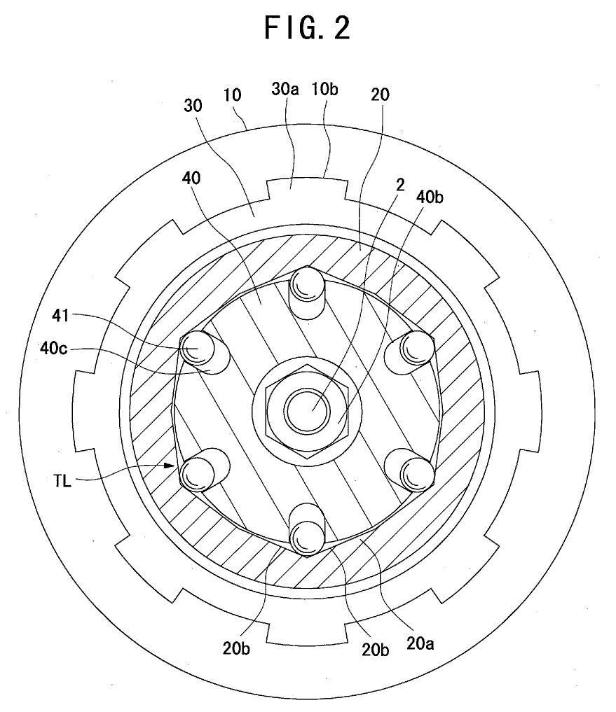

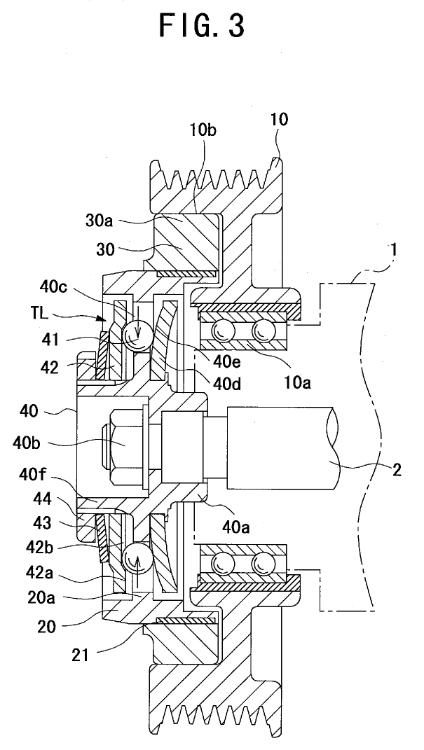

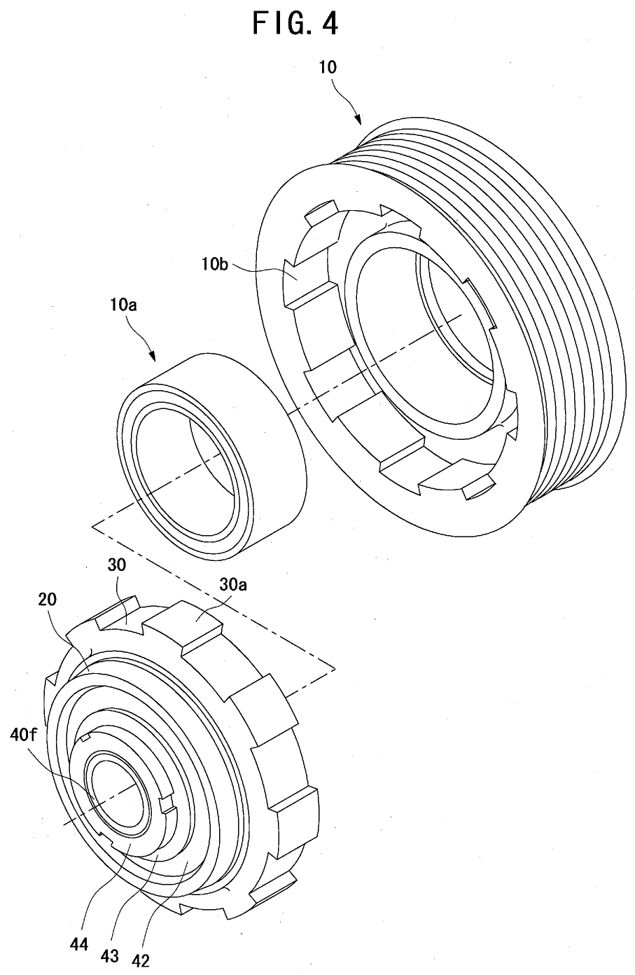

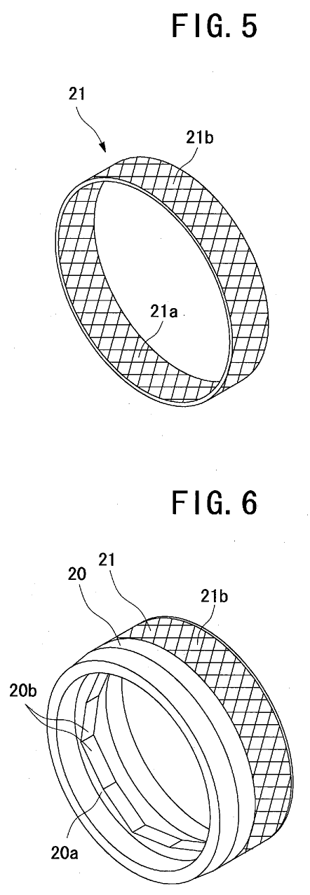

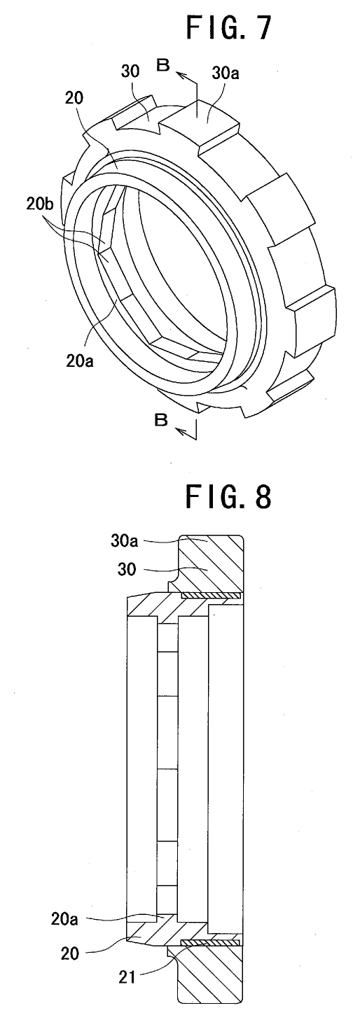

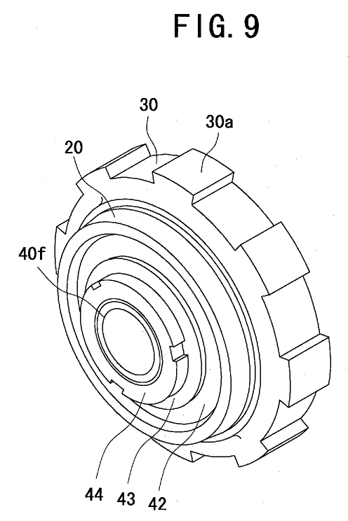

FIGS. 1 to 9 show a first embodiment of the present invention. FIG. 1 is a side sectional view of a power transmission device in accordance with a first embodiment of the present invention, FIG. 2 is a sectional view taken along the line A-A of FIG. 1, FIG. 3 is a side sectional view of a power transmission device, showing the operation thereof at the power cutoff time, FIG. 4 is a perspective view showing a state before a cushioning rubber and a pulley are assembled, FIG. 5 is a perspective view of a torque transmission ring, FIG. 6 is a perspective view of an inner ring, FIG. 6 is a perspective view of an inner ring, FIG. 8 is a sectional view taken along the line B-B of FIG. 7, FIG. 9 is a perspective view of an inner ring to which a cutoff mechanism is assembled.

A power transmission device in accordance with this embodiment is used for a compressor of a vehicular air conditioner, and transmits power to a drive shaft 2 projecting from one end of a compressor body 1.

This power transmission device includes a pulley 10 capable of being rotated by the power from an engine, an inner ring 20 disposed on the inside in the radial direction of the pulley 10, a cushioning rubber 30 disposed between the pulley 10 and the inner ring 20, a hub 40 which is disposed on the inside in the radial direction of the inner ring 20 and which is capable of being rotated together with the drive shaft 2, and a cutoff mechanism TL disposed between the inner ring 20 and the hub 40. The pulley 10 corresponds to a first rotor described in claims. The inner ring 20 corresponds to a second rotor described in claims. The cushioning rubber 30 corresponds to a cushioning member described in claims. The hub corresponds to a third rotor described in claims.

The pulley 10 is made of a thermosetting material such as phenolic resin, and around the outer peripheral surface of the pulley 10 is set a V belt, not shown. A bearing 10a is provided between the inner peripheral surface on one end side in the axial direction of the pulley 10 and the compressor body 1. The pulley 10 is supported rotatably on the compressor body 1 by the bearing 10a. The power of the engine, not shown, is transmitted to the pulley 10 via the V belt, the pulley 10 is rotated. A plurality of concave portions 10b are provided in the inner peripheral surface on the other end side in the axial direction of the pulley 10. The concave portions 10b are arranged at intervals in the circumferential direction with each other.

The inner ring 20 is made of a thermosetting material such as phenolic resin. A contact portion 20a is provided on the inner peripheral surface of the inner ring 20, and the contact portion 20a can come into contact with each of balls 41, described later, from the outside in the radial direction. The contact portion 20a has a plurality of first inclined faces 20b on the inner peripheral surface thereof, and the first inclined faces 20b make a predetermined angle therebetween. The inner ring 20 has a torque transmission ring 21 on the outer peripheral surface on one end side in the axial direction. The torque transmission ring 21 is placed in a mold when the inner ring 20 is injection molded. Thereby, the torque transmission ring 21 is fixed on the outer peripheral surface of the inner ring 21 (refer to FIG. 6). The torque transmission ring 21 increases the fixing strength between the inner ring 21 and the cushioning rubber 30.

As shown in FIG. 5, the torque transmission ring 21 is a metallic ring the surface of which is coated with a thermosetting material such as phenolic resin. The metallic ring is made of aluminum, steel, or the like. Also, the ruggedness is formed on an inner peripheral surface 21a and an outer peripheral surface 21b of the metallic ring before the coating of thermosetting material is applied. The ruggedness is formed by knurling or shot blasting.

The cushioning rubber 30 is formed by injection molding of a rubber material performed after the inner ring 20 has been placed in a mold. The rubber material is EPDM, IIR, silicone, or the like. The cushioning rubber 30 is molded into a ring shape on the outer peripheral surface of the inner ring 20 (refer to FIGS. 7 and 8). Thereby, the inner peripheral surface of the cushioning rubber 30 is fixed to the inner ring 20 and the torque transmission ring 21. The outer peripheral surface of the cushioning rubber 30 has a plurality of (eight in this embodiment) convex portions 30a. The convex portions 30a project in the radial direction of the cushioning rubber 30. The convex portions 30a are arranged at intervals in the circumferential direction of the cushioning rubber 30 with each other. The convex portions 30a are fitted in the concave portions 10b in the pulley 10. The shape of the outer peripheral surface of the cushioning rubber 30 is slightly smaller than the shape of the inner peripheral surface of the pulley 10. Therefore, the cushioning rubber 30 can be fitted in the pulley 10 easily.

The hub 40 has a disc shape, and is disposed on the inside in the radial direction of the inner ring 20. A connecting portion 40a is provided on one end surface in the axial direction of the hub 40. The connecting portion 40a has a serration or a key groove capable of connecting with the drive shaft 2. The hub 40 is fixed to the drive shaft 2 by a nut 40b. Also, in the case in which a torque larger than a predetermined amount is produced between the inner ring 20 and the hub 40, the transmission of turning force from the inner ring 20 to the hub 40 is cut off by the cutoff mechanism TL.

The cutoff mechanism TL has a plurality of ball grooves 40c provided at intervals in the circumferential direction with each other on the outer peripheral surface side of the hub 40, the balls 41 disposed in the ball grooves 40c, and the balls 41 which are movable in the radial direction of the hub 40, each of the first inclined faces 20b of the inner ring 20, a contact plate 40d disposed on one end surface side in the axial direction of the hub 40, and a pressing ring 42 disposed on the other end surface side in the axial direction of the hub 40. The pressing ring 42 corresponds to an urging member described in claims.

Each of the balls 41 is in contact with each of the ball grooves 40c in the circumferential direction of the hub 40.

The contact plate 40d is fixed to the hub 40 by welding or partial deformation of the hub 40. A second inclined face 40e is provided on the ball groove 40c side of the contact plate 40d. The inside in the radial direction of the second inclined face 40e is convex to the hub 40 side. The second inclined face 40e is in contact with the balls 41 in the ball grooves 40c in the axial direction. Also, An extending portion 40f is provided in the central portion in the radial direction on the other end surface side in the axial direction of the hub 40. The extending portion 40f has a cylindrical shape, and extends in the axial direction so as to cover the nut 40b.

The pressing ring 42 urges the balls 41 to the second inclined face 40e side. The pressing ring 42 engages with the extending portion 40f of the hub 40 so as to be movable in the axial direction. A contact portion 42a is provided on the outer peripheral surface side of one end surface in the axial direction of the pressing ring 42 so as to be in contact with the balls 41 in the axial direction. A concave portion 42b is provided on the inside in the radial direction of the contact portion 42a. The concave portion 42b is formed in a concave shape in the axial direction.

A belleville spring 43 is disposed on the other end surface side of the pressing ring 42. The belleville spring 43 engages with the extending portion 40f of the hub 40 so as to be movable in the axial direction. The belleville spring 43 urges the pressing ring 42 to each of the balls 41 side. The belleville spring 43 is disposed between an annular nut 44 and the pressing ring 42 in a compressed state. The nut 44 engages threadedly with the extending portion 40f. By adjusting the tightening force of the nut 44, the urging force created by the belleville spring 43 can be set arbitrarily.

That is to say, the balls 41 in the ball grooves 40c are guided to the outside in the radial direction by the second inclined face 40e, and the balls 41 come into contact with the first inclined faces 20b of the inner ring 20.

In the above-described power transmission device, when the engine power is transmitted to the pulley 10, the concave portions 10b of the pulley 10 and the convex portions 30a of the cushioning rubber 30 engage with each other in the circumferential direction. Thereby, the turning force of the pulley 10 is transmitted to the outer peripheral surface of the cushioning rubber 30. Also, since the inner peripheral surface of the cushioning rubber 30 is fixed to the inner ring 20, the turning force of the cushioning rubber 30 is transmitted to the inner ring 20. At this time, the cushioning rubber 30 transmits turning force while being deformed elastically in the shear direction between the outer peripheral surface and the inner peripheral surface. Thereby, the rotational fluctuations transmitted from the engine side are absorbed.

Also, the turning force transmitted to the inner ring 20 is transmitted to the ball grooves 40c of the hub 40 via the first inclined faces 20b and the balls 41. Thereby, the drive shaft 2 is rotated together with the hub 40. At this time, the balls 41 are pressed in the axial direction by the urging force of the belleville spring 43, and the balls 41 are guided to the outside in the radial direction of the ball grooves 40c by the second inclined face 40e of the hub 40. The balls 41 guided to the outside in the radial direction come into contact with the first inclined faces 20b. That is to say, the turning force of the inner ring 20 is transmitted to the hub 40.

Here, if an excessive rotational load is applied to the pulley 10 side, for example, by a failure of compressor, a torque larger than the predetermined amount is produced between the inner ring 20 and the hub 40. Therefore, the balls 41 are pushed to the inside in the radial direction by the first inclined faces 20b of the contact portion 20a, so that the balls 41 move to the inside in the radial direction in the ball grooves 40c against the urging force of the belleville spring 43 (refer to FIG. 3). Thereby, the balls 41 are held on the inside in the radial direction by the concave portion 42b of the pressing ring 42 and the contact plate 40d. Since the balls 41 are restrained at positions where the balls 41 do not come into contact with the contact portion 40a, the inner ring 20 runs idly with respect to the hub 40. That is to say, the transmission of turning force from the pulley 10 side to the drive shaft 2 is cut off.

Thus, in this embodiment, the ring-shaped cushioning rubber 30 is provided on the outer peripheral surface of the inner ring 20. The plurality of convex portions 30a are provided on the outer peripheral surface of the cushioning rubber 30 at intervals in the circumferential direction with each other. The plurality of concave portions 10b are provided on the inner peripheral surface of the pulley 10 at intervals in the circumferential direction. The convex portions 30a are fitted in the concave portions 10b. Thereby, the turning force of the pulley 10 is transmitted to the outer peripheral surface of the cushioning rubber 30. Also, turning force is transmitted from the inner peripheral surface of the cushioning rubber 30 to the inner ring 20. That is to say, the cushioning rubber 30 transmits turning force while being deformed elastically in the shear direction between the pulley 10 and the inner ring 20. Thereby, the rotational fluctuations transmitted from the engine are absorbed by the cushioning member 30. Therefore, the cushioning rubber 30 is not deformed elastically in the repeated compression direction, so that permanent deformation in the compression direction does not occur in the cushioning rubber 30. That is to say, the cushioning effect does not decrease, and therefore the cushioning effect due to the cushioning rubber 30 can be maintained for a long period of time.

Also, the cushioning rubber 30 is molded on the outer peripheral surface of the inner ring 20. By fitting the convex portions 30a of the cushioning rubber 30 in the concave portions 10b of the pulley 10, the cushioning rubber 30 is connected to the pulley 10. Therefore, the work for assembling the cushioning rubber 30 to the pulley 10 is easy to perform, so that the manufacturing cost can be reduced.

Further, the shape of the outer peripheral surface of the cushioning rubber 30 is slightly smaller than the shape of the inner peripheral surface of the pulley 10. Therefore, the work for assembling the cushioning rubber 30 can be performed more easily. Although the shape of the outer peripheral surface of the cushioning rubber 30 is formed so as to be slightly smaller than the shape of the inner peripheral surface of the pulley 10, when the pulley 10 rotates and thereby turning force is transmitted to the inner ring 20, the outer peripheral surface of the cushioning rubber 30 is brought into close contact with the inner peripheral surface of the pulley 10 by a centrifugal force. That is to say, no gap is produced between the pulley 10 and the cushioning rubber 30, so that harmful vibrations do not occur from between the pulley 10 and the cushioning rubber 30.

Also, in the case in which a torque larger than the predetermined amount is produced between the inner ring 20 and the hub 40, the balls 41 are moved to the inside in the radial direction by the first inclined faces 20b of the inner ring 20. Thereby, the transmission of turning force from the inner ring 20 to the hub 40 is cut off. That is to say, when the compressor fails, an excessive rotational load is not applied to the pulley 10 side for a long period of time, so that the belt can be prevented from being damaged.

Further, the torque transmission ring 21 is disposed between the cushioning rubber 30 and the inner ring 20. The torque transmission ring 21 is a metallic ring in which the surface is coated with a thermosetting material such as phenolic resin. Thereby, the cushioning rubber 30 and the torque transmission ring 21 are fixed firmly to each other. Also, the torque transmission ring 21 and the inner ring 20 are fixed firmly to each other. Therefore, the inner ring 20 and the cushioning rubber 30 can be fixed firmly to each other. That is to say, turning force can be transmitted surely for a long period of time.

Also, the ruggedness is formed on the outer peripheral surface 21a and the inner peripheral surface 21b of metallic ring of the torque transmission ring 21. Thereby, the cushioning rubber 30 and the torque transmission ring 21 are fixed more firmly to each other. Also, the torque transmission ring 21 and the inner ring 20 are fixed more firmly to each other. That is to say, the reliability of power transmission for a long period of time is improved.

Further, the torque transmission ring 21 is placed in a mold when the inner ring 20 is injection molded. Thereby, the torque transmission ring 21 is fixed on the outer peripheral surface of the inner ring 20. Therefore, the inner ring 20 and the torque transmission ring 21 are fixed firmly to each other. That is to say, the reliability of power transmission for a long period of time is improved.

In this embodiment, the torque transmission ring 21 is a metallic ring in which the surface is coated with a thermosetting material. Alternatively, the torque transmission ring 21 can be made of a thermosetting material only. In this case, the torque transmission ring 21 can be injection molded on the outer peripheral surface of the inner ring 20.

Also, in this embodiment, the inner ring 20 is made of a thermosetting resin. Alternatively, the inner ring 20 can be made of a metallic material. In this case, by fitting the torque transmission ring 21 on the outer peripheral surface of the inner ring 20, the torque transmission ring 21 is attached onto the outer peripheral surface of the inner ring 20. Further, in the case in which the torque transmission ring 21 is made of a thermosetting material, the inner ring 20 can be placed in a mold when the torque transmission ring 21 is injection molded. Thereby, the torque transmission ring 21 is fixed on the outer peripheral surface of the inner ring 20.

In this embodiment, the torque transmission ring 21 is provided on the outer peripheral surface of the inner ring 20. Also, the surface of the torque transmission ring 21 is coated with a thermosetting material. Thereby, the torque transmission ring 21 and the cushioning rubber 30 are fixed firmly to each other. Alternatively, an adhesion layer for vulcanization bonding can be provided between the torque transmission ring 21 and the cushioning rubber 30.

Also, in this embodiment, the convex portions 30a of the cushioning rubber 30 each have a rectangular shape. Alternatively, the convex portions 30a can be provided by gradually changing the outside diameter of the outer peripheral surface of the cushioning rubber 30.

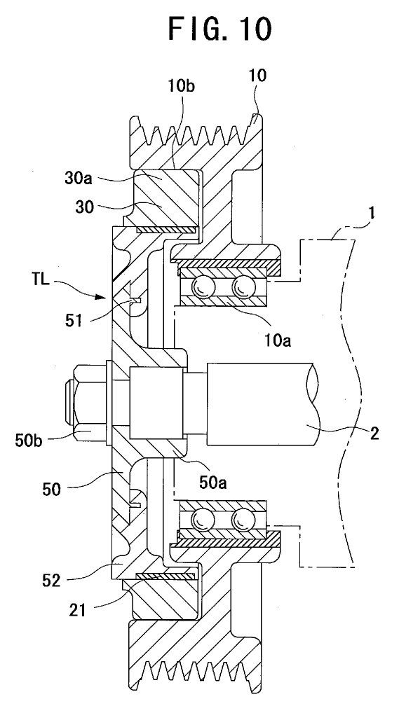

FIG. 10 is a side sectional view of a power transmission device in accordance with a second embodiment of the present invention. In this figure, the same symbols refer to the same elements as those in the first embodiment.

This embodiment includes a modification of the cutoff mechanism TL described in the first embodiment. This cutoff mechanism TL is configured as described below. A hub 50 is made of a metallic material such as aluminum, and has a disc shape. The hub 50 has a connecting portion 50a on one end surface in the axial direction. The connecting portion 50a has a serration or a key groove capable of connecting with the drive shaft 2. The hub 50 is fixed to the drive shaft 2 by a nut 50b. A plurality of pins 51 are provided on the outer peripheral surface side of one end surface in the axial direction of the hub 50. The pins 51 are arranged at intervals in the circumferential direction with each other. The pins 51 are formed so as to extend in the axial direction. A torque plate 52 is formed on the outer peripheral surface side of the hub 50. The torque plate 52 is made of a thermosetting material such as phenolic resin. The torque plate 52 is formed so as to cover the pins 51. The torque transmission ring 21 is provided on the outer peripheral surface on one end side in the axial direction of the torque plate 52. The ring-shaped cushioning rubber 30 is fixed on the outer peripheral surfaces of the torque plate 52 and the torque transmission ring 21. Other configurations are the same as those of the first embodiment.

In the above-described power transmission device, the turning force of the cushioning rubber 30 is transmitted to the torque plate 52. Also, the turning force is transmitted to the hub 50 via the pins 51. If an excessive rotational load is applied to the pulley 10 side, for example, by a failure of compressor, a torque larger than the predetermined amount is produced between the torque plate 52 and the hub 50. Thereby, the pins 51 are broken on the hub 50 side, and thereby the transmission of turning force from the torque plate 52 to the hub 50 is cut off. Therefore, when an excessive rotational load is applied to the pulley 10 side, for example, by a failure of compressor, the belt is prevented from being damaged. The amount of torque such that the pins 51 are broken can be set arbitrarily depending on the outside diameter of each of the pins 51, the distance thereof from the center of the hub 50, and the number of pins 51.

The preferred embodiments described in this specification are illustrative and not restrictive. The scope of invention is given by the appended claims, and all changes and modifications included in the meaning of claims are embraced in the present invention.

1. A power transmission device comprising:
a first rotor capable of being rotated by power from the outside;
a second rotor disposed on the inside in the radial direction of the first rotor;
a ring-shaped cushioning member for transmitting turning force from the first rotor to the second rotor, the cushioning member which is disposed between the first rotor and the second rotor, and the cushioning member in which the inner peripheral surface is fixed to the outer peripheral surface of the second rotor;
a third rotor disposed on the inside in the radial direction of the second rotor;
a cutoff mechanism which is disposed between the second rotor and the third rotor, the cutoff mechanism which is capable of transmitting turning force from the second rotor to the third rotor, and the cutoff mechanism which cuts off the turning force transmitted from the second rotor to the third rotor in the case in which a torque larger than a predetermined amount is produced between the second rotor and the third rotor;
a plurality of convex portions provided at intervals in the circumferential direction with each other on the outer peripheral surface of the cushioning member; and
a plurality of concave portions which are provided in the inner peripheral surface of the first rotor, and the concave portions which are fitted on the convex portions of the cushioning member.

2. The power transmission device according to claim 1, wherein
the cutoff mechanism has:
a plurality of ball grooves provided at intervals in the circumferential direction on the outer peripheral surface side of the third rotor;
a plurality of balls which are in contact with the ball grooves in the circumferential direction of the third rotor, and the balls which are movable in the ball grooves in the radial direction of the third rotor;
a plurality of first inclined faces which are provided on the inner peripheral surface of the second rotor, and the first inclined faces which are capable of coming into contact with the balls from the outside in the radial direction;
a second inclined face which is in contact with the balls in the axial direction of the third rotor, and the second inclined face in which the inside in the radial direction is convex to the third rotor side; and
an urging member for bringing the balls into contact with the first inclined faces by urging the balls to the second inclined face, and
each of the balls transmits turning force from the second rotor to the third rotor by means of contacting with the first inclined faces, and in the case in which a torque larger than the predetermined amount is produced between the second rotor and the third rotor, the balls are pushed by the first inclined faces, and the balls move in the ball grooves to the inside in the radial direction of the third rotor against the urging force of the urging member, whereby the turning force transmitted from the second rotor to the third rotor is cut off.

3. The power transmission device according to claim 1, wherein
the cutoff mechanism has a connecting member for transmitting turning force from the second rotor to the third rotor by means of connecting the second rotor with the third rotor, and
the connecting member cuts off the turning force transmitted from the second rotor to the third rotor by breaking in the case in which a torque larger than the predetermined amount is produced between the second rotor and the third rotor.

4. The power transmission device according to claim 1, further comprising:
a torque transmission ring in which the inner peripheral surface is fixed to the outer peripheral surface of the second rotor, and the torque transmission ring in which the outer peripheral surface is fixed to the inner peripheral surface of the cushioning member.

5. The power transmission device according to claim 4, wherein
the torque transmission ring is made of a thermosetting material.

6. The power transmission device according to claim 4, wherein
the torque transmission ring is a metallic ring in which the surface is coated with a thermosetting material.

7. The power transmission device according to claim 6, wherein
the metallic ring has a ruggedness on the inner peripheral surface and the outer peripheral surface.

8. The power transmission device according to claim 6, wherein
the metallic ring is made of aluminum.

9. The power transmission device according to claim 6, wherein
the metallic ring is made of steel.

10. The power transmission device according to claim 4, wherein
the torque transmission ring is fixed on the outer peripheral surface of the second rotor by means of injection molding of the second rotor after the torque transmission ring has been placed in a mold.

11. The power transmission device according to claim 1, wherein
the first rotor is made of a thermosetting material.
